(19) United States
(12) Patent Application Publication
(10) Pub. No.: US 2016/0292630 A1
(43) Pub. Date: Oct. 6, 2016

(54) PRODUCT IDENTIFIER SYSTEMS AND METHODS

(71) Applicant: Wal-Mart Stores, Inc., Bentonville, AR (US)

(72) Inventors: Nicholaus A. Jones, Fayetteville, AR (US); Marc A. Fletter, Bentonville, AR (US); Matthew A. Jones, Bentonville, AR (US); Daniel R. Shields, Rogers, AR (US); Robert J. Taylor, Rogers, AR (US); Bruce W. Wilkinson, Rogers, AR (US)

(21) Appl. No.: 15/087,595

(22) Filed: Mar. 31, 2016

Related U.S. Application Data
(60) Provisional application No. 62/142,973, filed on Apr. 3, 2015.

(51) Int. Cl. G06Q 10/08; G06K 9/62

(52) U.S. Cl. CPC G06Q 10/087; G06K 9/6232

(57) ABSTRACT

Methods and apparatuses are provided for use in tracking product consumption. Some embodiments provide a shopping facility management system comprising: an inventory database; a symbol database; a control circuit; and a memory storing computer instructions that cause the control circuit to: identify a first product physically at a shopping facility that is to be found within the shopping facility; obtain a unique identifier of the first product; access the symbol database; identify a first set of pictorial, non-alphanumeric symbols exclusively corresponding to the unique identifier; and communicate to the shopping facility worker the first set of symbols in association with an act to be performed corresponding to finding the first product such that the first product is visibly identifiable through a visual comparison of the first set of symbols to multiple different sets of symbols affixed to multiple different products within the shopping facility.

### RELATED APPLICATIONS

This application claims the benefit of U.S. Provisional Application No. 62/142,973, filed Apr. 3, 2015, for Jones et al., entitled PRODUCT IDENTIFIER SYSTEMS AND METHODS, Docket No. 8842-134370-US (483US01), which is incorporated herein by reference in its entirety.

### TECHNICAL FIELD

These teachings relate generally to shopping facilities and more particularly to devices, systems and methods for assisting in identifying products.

### BACKGROUND

Shopping facilities typically stock thousands or more products for purchase by customers. The products may be stored on the retail floor accessible to customers as well as in back stock areas. Further, different workers place products in the stock area and out on the retail floor.

Accordingly, the larger numbers of products are distributed throughout the shopping facility. The products may be in shipping boxes or may be on display. Identifying a product can be difficult because of where a product was placed and/or a positioning of the product.

### BRIEF DESCRIPTION OF THE DRAWINGS

Disclosed herein are embodiments of apparatuses and methods pertaining to providing multiple customers with a cooperative shopping experience. This description includes drawings, wherein:

FIG. 1 illustrates a simplified block diagram of an exemplary shopping facility management system of a shopping facility, in accordance with some embodiments;

FIG. 2 shows a simplified block diagram of an exemplary central computer system, in accordance with some embodiments;

FIG. 3 shows a simplified block diagram of an exemplary user interface unit (UIU), in accordance with some embodiments;

FIG. 4 illustrates a simplified plane view of an exemplary rack, case, shelving, or the like with multiple shelves, bins, or other such structures to support and/or hold one or more products or shipping packaging of products at the shopping facility;

FIG. 5 illustrates a simplified flow diagram of an exemplary process allowing a shopping facility worker or other individual to distinguish and locate a product of interest, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Many shopping facilities rely on bar codes or other such machine readable codes to identify products and distinguish between products. Typically, these machine readable codes cannot effectively be read by humans, and instead shopping facility workers must use a code reading machine (generally referred to as a code reader). For example, in requesting that a shopping facility worker locate a particular product (e.g., in a back stock area to be moved to the retail floor), the worker typically has to be provided with a portable code reader that is programmed with a unique code of a product that the worker is supposed to locate. Using the code reader, the worker has to proceed through the shopping facility or an area of a shopping facility and read numerous different codes in attempts to locate a particular product through trial and error. The locating of a desired product through machine readable code can be further complicated when the packaging of the product is unfamiliar to the shopping facility worker, the labeling of the package is in a foreign language, the packaging is not readily visible (e.g., due to shipping packaging), the packaging of the particular product trying to be located is very similar to a related but different product, and/or other such issues. Such issues inhibit the shopping facility worker in identifying a desired product and inhibit a working from narrowing down the trial and error of using the code reader to read codes in attempts to locate the product of interest.

Generally speaking, pursuant to various embodiments, systems, devices and methods are provided that utilize simple and easily recognizable series or sets of symbols that distinguish one product from other products at the shopping facility. A set of symbols can be positioned on the package and/or shipping packaging so that the symbols are readily visible. When the product is placed on a shelf, bin, case, or other such storage structure, the series of symbols are visible and can be used to visually distinguish a product from other products.

Some embodiments allow products, crates, pallets or other such packaging of products to be labeled with easily identifiable symbols that distinguish a product from all other products at a shopping facility. Typically, each product has a set of two or more symbols exclusively associated with that product. The set of symbols are printed on or otherwise affixed to the product and/or packaging and are readily visible. Utilizing these unique sets of symbols shopping facility workers (e.g., associates, colleagues, analysts, etc.) can visually distinguish a particular product from the other products, and typically from all other products, without having to use a bar code reader or other such machine that is configured to read machine readable codes.

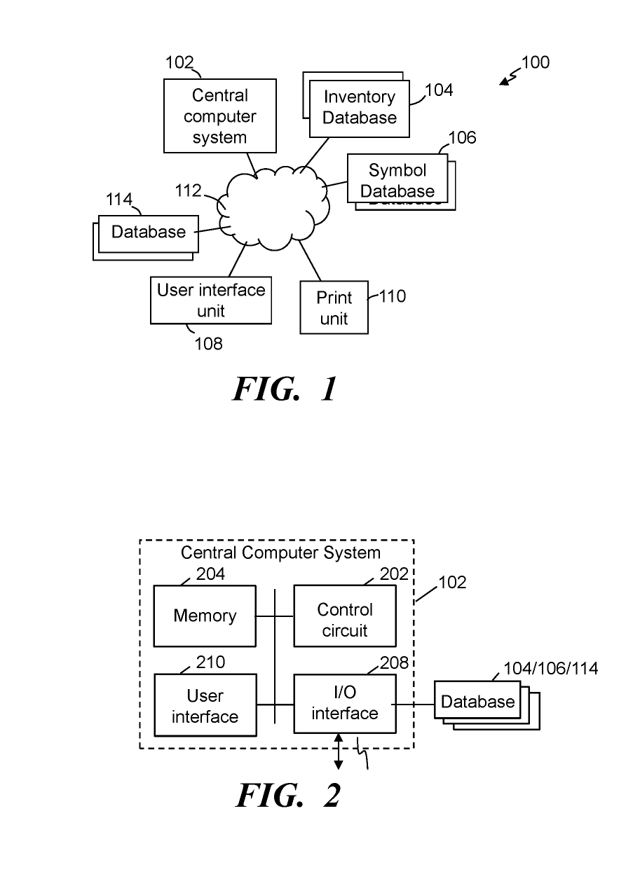

FIG. 1 illustrates a simplified block diagram of an exemplary shopping facility management system 100 of a shopping facility, in accordance with some embodiments. The management system includes a central computer system 102 (sometimes referred to as a central controller), and one or more databases, such as an inventory database 104 and a symbol database 106. In some embodiments, the management system further includes and/or communicates with one or more user interface units 108. Additionally, the management system may include or communicate with one or more print units 110. Further, the management system typically includes and/or couples with one or more wired and/or wireless distributed communication network 112 (e.g., WAN, LAN, Internet, cellular, other such networks, and combinations of such networks).

The central computer system 102 is configured to identify products, and utilize the symbol database 106 to identify for each product a unique set or series of symbols corresponding to a unique identifier of the product. These sets of symbols can be provided to a human worker at the shopping facility. With these symbols the shopping facility worker can readily distinguish an intended product from other products. In some embodiments, the central computer system 102 is in communication with the inventory database 104 and accesses the inventory database to identify one or more products of interest. For example, a product may need to be retrieved from a back storage area and brought to the retail floor of the shopping facility that is accessible to customers. The central computer system obtains a unique identifier of the product of interest, for example, from the inventory database. In some instances, the central computer system in cooperation with an inventory tracking system, which may be part of or separate from the central computer system, may detect that restocking of the product of interest is needed. In some embodiments, the unique identifier corresponds to a bar code on the product and that uniquely identifies the product from the other products at the shopping facility.

The central computer system is further in communication with the symbol database 106. Utilizing the unique identifier of the product, the central computer system accesses the symbol database 106 to identify and/or obtain for each product of interest a unique set or series of symbols corresponding to the unique identifier of each of the products of interest. The one or more sets of symbols can be provided to a human worker at the shopping facility. With the one or more sets of symbols the shopping facility worker can readily distinguish an intended product from other products.

In some embodiments, the central computer system is in communication with the one or more user interface units 108. The user interface units 108 can be substantially any relevant device configured to wired and/or wirelessly communicate with the central computer system. Accordingly, the user interface units allow a user (e.g., shopping facility worker, customer, etc.) to communicate with the central computer system to supply and/or receive relevant information and communications, communicate with one or more other user interface units 108, often through the shopping management systems, and other such communications. For example, the user interface units may include but are not limited to smart phones, cell phones, laptops, tablets, shopping facility specific wireless communication devices, or other such consumer electronic user devices.

Some embodiments include one or more print units 110 that are in communication with the central computer system 102. In some implementations, one or more sets of symbols for corresponding one or more products of interest can be communicated to the print units to be printed. Workers can utilize the printouts of the one or more sets of symbols in locating the one or more products of interest.

Further, in many instances, the supplier of a product affixes and/or prints one or more sets of symbols to the product packaging and/or shipping packaging. However, some products may be received at a shopping facility without sets of symbols uniquely identifying the products on the product packaging and/or the shipping packaging. Accordingly, in some implementations, the central computer system may cause one or more of the print units 110 to print one or more relevant labels at a desired size or sizes with the unique set or set of symbols corresponding to the unique product identifier of each relevant product.

In some embodiments, the management system 100 may further include or be in communication with one or more additional databases 114 that can be accessed by at least the central computer system 102. The databases 114 can store substantially any relevant information such as but not limited to product information (e.g., inventory, types of products, details about products, pricing, etc.), shopping facility information, location information, store mapping information, commands, codes, code location mapping, software, applications, executables, log and/or historic information, other such relevant information, and typically a combination of two or more of such information. Similarly, some or all of the information stored and/or accessible through the one or more databases 104, 106, 114 may be stored at one or more of the central computer system 102, the user interface units 108, and the like. Further, in some implementations, one or more databases 104, 106, 118 may be external to the management system 100 and/or geographically distributed over multiple storage devices, which may include duplicate information for redundancy.

The management system 100 may be utilized with a single shopping facility (e.g., such as a store location, shopping mall, retail campus or the like), while in other implementations, the shopping management system may extend across multiple shopping facility locations. For simplicity, the embodiments herein are described with respect to a single shopping facility. It will be appreciated by those skilled in the art that some embodiments can be applicable to multiple shopping facilities and/or the management of cooperative shopping experiences at one or more shopping facilities. Further, the shopping management system may be operated local at a shopping facility location or remote from the shopping facility location.

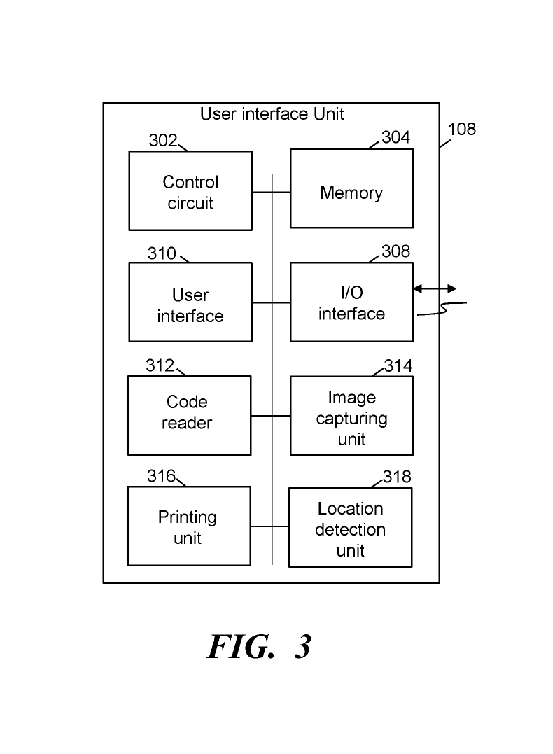

FIG. 2 shows a simplified block diagram of an exemplary central computer system 102, in accordance with some embodiments. The central computer system includes one or more control circuits 202, memory 204, and input/output (I/O) interfaces 208. Further, the central computer system 102 typically includes one or more user interfaces 210 configured to allow users to interact with the central computer system. In some embodiments, the central computer system 102 may further include additional components and/or communicationally couple with other components and/or systems, such as but not limited to a shopping facility a checkout or point of sale (POS) system, inventory system, security system, distribution center system, video recording system and/or units, and/or other such systems, units and/or components. In some embodiments, the central computer system 102 and/or the control circuit 202 can be implemented through one or more servers operated remote from the shopping facility and in communication with an interface circuit at the shopping facility.

In some embodiments, the control circuit 202 includes one or more processors and/or microprocessors. The control circuit couples with and/or includes the memory 204. Generally, the memory 204 stores the operational code or set of instructions that is executed by the control circuit 202 and/or processor to implement the functionality of the central computer system. In some embodiments, the memory 204 may also store some or all of particular data that may be needed obtain product identifiers and corresponding sets of symbols for products, make any of the determinations and/or corrections described herein, and the like. Such data may be pre-stored in the memory or be received, for example, from the databases, the user interface units, remote product manufacturers, suppliers and the like, distribution center systems, inventory systems, other sources, or combinations of such sources. It is understood that the control circuit may be implemented as one or more processor devices as are well known in the art. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the central computer system; however, the memory 204 can be internal, external or a combination of internal and external memory. Additionally, the central computer system may include a power supply (not shown) or it may receive power from an external source. In some instances, the control circuit 202 and the memory 204 may be integrated together, such as in a microcontroller, application specification integrated circuit, field programmable gate array or other such device, or may be separate devices coupled together.

The one or more I/O interfaces 208 allow wired and/or wireless communication coupling of the central computer system to external components, such as the databases, the user interface units 108, remote servers, and other such components. Accordingly, the I/O interface 208 may include any known wired and/or wireless interfacing device, circuit and/or connecting device. For example, in some implementations, the I/O interface 208 includes one or more transceivers, receivers, and/or transmitters that provide wireless communication in accordance with one or more wireless protocols (e.g., Wi-Fi, Bluetooth, radio frequency (RF), cellular, other such wireless communication, or combinations of such communication).

One or more user interfaces 210 can be included in and/or coupled with the central computer system, and can include substantially any known input device, such one or more buttons, knobs, selectors, switches, keys, touch input surfaces and/or displays, etc. Additionally, the user interface may include one or more output display devices, such as lights, visual indicators, display screens, etc. to convey information to a user, such as status information, location information, mapping information, customer information, worker information, motorized transport unit information, power and/or power storage levels, product location information, product information, video content, operating status information, notifications, errors, conditions and/or other such information. While FIG. 2 illustrates the various components being coupled together via a bus, it is understood that the various components may actually be coupled to the control circuit 202 and/or one or more other components directly.

In some embodiments, the control circuit 202 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

FIG. 3 shows a simplified block diagram of an exemplary user interface unit 108 (UIU), in accordance with some embodiments. The user interface unit includes one or more control circuits 302, memory 304, input/output (I/O) interfaces and/or device 308, and user interfaces 310. In some implementations, the user interface unit may further include one or more code readers 312, image capturing unit 314, print unit 316, location detection unit 318, and/or other such systems or units.

The control circuit 302 typically comprises one or more processors and/or microprocessors. The memory 304 stores the operational code or set of instructions that is executed by the control circuit 302 and/or processor to implement the functionality of the user interface unit 108. In some embodiments, the memory 304 may also store some or all of particular data that may be needed to make any of the associations, determinations, measurements and/or communications described herein. Such data may be pre-stored in the memory, received from an external source (e.g., the central computer system 102), be determined, and/or communicated to the user interface unit. It is understood that the control circuit 302 and/or processor may be implemented as one or more processor devices as are well known in the art. Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the user interface unit 108; however, the memory 304 can be internal, external or a combination of internal and external memory. Additionally, the user interface unit typically includes a power supply (not shown) that is typically rechargeable, and/or it may receive power from an external source. While FIG. 3 illustrates the various components being coupled together via a bus, it is understood that the various components may actually be coupled to the control circuit 302 and/or one or more other components directly.

Generally, the control circuit 302 and/or electronic components of the user interface unit 108 can comprise fixed-purpose hard-wired platforms or can comprise a partially or wholly programmable platform. These architectural options are well known and understood in the art and require no further description here. The user interface unit and/or control circuit can be configured (for example, by using corresponding programming as will be well understood by those skilled in the art) to carry out one or more of the steps, actions, and/or functions described herein. In some implementations, the control circuit 302 and the memory 304 may be integrated together, such as in a microcontroller, application specification integrated circuit, field programmable gate array or other such device, or may be separate devices coupled together.

The I/O interface 308 allows wired and/or wireless communication coupling of the user interface unit 108 to external components, such as the central computer system 102, databases, print units 110, remote sources and/or services, distribution centers, and other such devices or systems. Typically, the I/O interface 308 provides at least wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitter, receiver, transceiver, etc.

The user interface 310 may be used for user input and/or output display. For example, the user interface 310 may include any known input devices, such one or more buttons, knobs, selectors, switches, keys, touch input surfaces, audio input, and/or displays, etc. Additionally, the user interface 310 may include one or more output display devices, such as lights, visual indicators, display screens, etc. to convey information to a user, such as symbols to be located, shopping facility location information, product information, identifier and/or code information, video content, other communication information (e.g., text messages, emails, etc.), status information, mapping information, product location information, operating status information, notifications, errors, conditions, and/or other such information. Similarly, the user interface 310 in some embodiments may include audio systems that can receive audio commands or requests verbally issued by a user, and/or output audio content.

In some embodiments, the user interface unit 108 may include one or more machine readable code readers 312 (sometimes referred to as a code reader) configured to detect and/or read machine readable codes positioned and distributed throughout at least some portions of a shopping facility. The code reader 312 can be configured to extract code information from the one or more machine readable codes that are read and/or detected, while in other embodiments, the control circuit extracts and/or identifies the code information. In some embodiments, the code reader reads and/or extracts code information corresponding to each machine readable code of a plurality of unique machine readable codes that are positioned to correspond to products placed at different locations throughout the shopping facility and detected by the code reader 312. The machine readable code reader 312 can be configured to optically read the machine readable codes of a plurality of unique machine readable codes. Typically, a shopping facility worker or other user activates the code reader 312 while being directed at a machine readable code (e.g., activated through a software application (APP) stored on and implemented though the user interface unit). For example, the worker may activate the code reader to confirm that the product attempting to be located has been accurately identified. Similarly, the scanning of a machine readable code may allow the user interface unit to communicate to the central computer system 102 that the item was found and/or receive a confirmation. Additionally or alternatively, in some instances the central computer system 102 may activate the code reader.

Additionally or alternatively, in some embodiments, the user interface unit may receive location information and/or include a location detection unit that is configured to determine a current location of the code reader, which can be provided to a worker, the central computer system 102, etc. In some embodiments, the location detection unit may include a machine readable location codes and/or identifier (e.g., placed throughout at least portions of the shopping facility and/or corresponding to products) that can be read by a code reader, global positioning satellite (GPS) information, Wi-Fi signal triangulation and/or evaluation, cellular tower triangulation, accelerometers, gyroscopes, compass, light identifier detection system, and/or other such location detection functionality. The location information provided through the location detection unit may be communicated to the central computer system or other system to provide a shopping facility worker with feedback regarding an anticipated location of a product the shopping facility worker is attempting to locate. Further, in some instances, the central computer system may identify, based on the location information, one or more tasks to be performed by the worker based on the determined location. For example, the central computer system may determine that a first product, which is located proximate to the location identified through the location detection unit of the user interface unit, is to be picked and moved onto the sales floor. An instruction can be communicated to the worker identifying the first product at least with set of symbols corresponding to the first product, and requesting that the first product be picked and move to the sales floor and/or a specific location on the sales floor.

In some embodiments, each machine readable code is unique and/or distinguishable from other machine readable codes. The machine readable codes can be substantially any relevant machine readable code, such as but not limited to, two dimensional barcode, radio frequency identifiers (RFID), near field communication (NFC) identifiers, ultra-wideband (UWB) identifiers, Bluetooth identifiers, images, or other such optically readable, radio frequency detectable or other such code, or combination of such codes. The machine readable code may be product identifications corresponding to products placed at positions on shelf at the shopping facility. Additionally or alternatively, in some embodiments, the code reader 312 comprises and/or utilizes the image capturing unit 314, which may comprise a camera, video camera or other such image capturing device that is configured to capture images, pictures, video, etc. of the machine readable code. The code reader, the control circuit 302, central computer system 102, or other device can be configured to perform an evaluation on the image and/or video captured (e.g., image recognition) to determine relevant code information from the one or more captured images. Additionally or alternatively, the image capturing unit 314 can be configured to capture images (e.g., pictures) of the sets of symbols on packaging. Image processing can also be performed on the images to detect and recognize the set of symbols.

Some embodiments additionally include a print unit 316. The printing unit can be configured to allow the user interface unit 108 to print one or more labels, images, sets of symbols or the like. As such, a shopping facility worker can be instructed to apply a label including a set of symbols to packaging. Using the user interface unit the shopping facility worker can print the label and apply the label to packaging. Similarly, a printout of a set of symbols may be printed and given to another shopping facility worker to allow the other shopping facility worker to visually identify a desired product.

Further, in some embodiments, the user interface unit 108 includes one or more location detection units 318 that are configured to determine a current location of the user interface unit and provide that information to a user, the central computer system 102, a communication service, and other such systems. In some embodiments, the location detection unit may include global positioning satellite (GPS) information, Wi-Fi signal triangulation and/or evaluation, cellular tower triangulation, accelerometers, gyroscopes, compass, light identifier detection system, machine readable location codes (e.g., placed throughout at least portions of the shopping facility and/or corresponding to products), and/or other such location detection functionality. The location information provided through the location detection unit can be used in determining, predicting, and/or fine tuning a location of the user interface unit. This location information may further be communicated to the central computer system or other system to provide a shopping facility worker with feedback regarding an anticipated location of a product the shopping facility worker is attempting to locate.

As described above and further below, products at the shopping facility can include one or more symbols that readily distinguish one product from other products at the shopping facility. Typically, a set of two or more symbols are printed, affixed or otherwise at least temporarily secured with a product and/or shipping packaging (e.g., box, wrapping, pallet, other such packaging, or combinations of two or more of such packaging that contain one or more products in their respective product packaging, and typically protect the one or more products and product packaging during shipment). Further, the set of symbols may be printed or affixed on multiple, if not all, of the sides of the product packaging and/or the shipping packaging. The set of symbols is readily visible and can be visually distinguished from other sets of symbols. As such, shopping facility workers and/or customers can visually distinguish a particular product from other products.

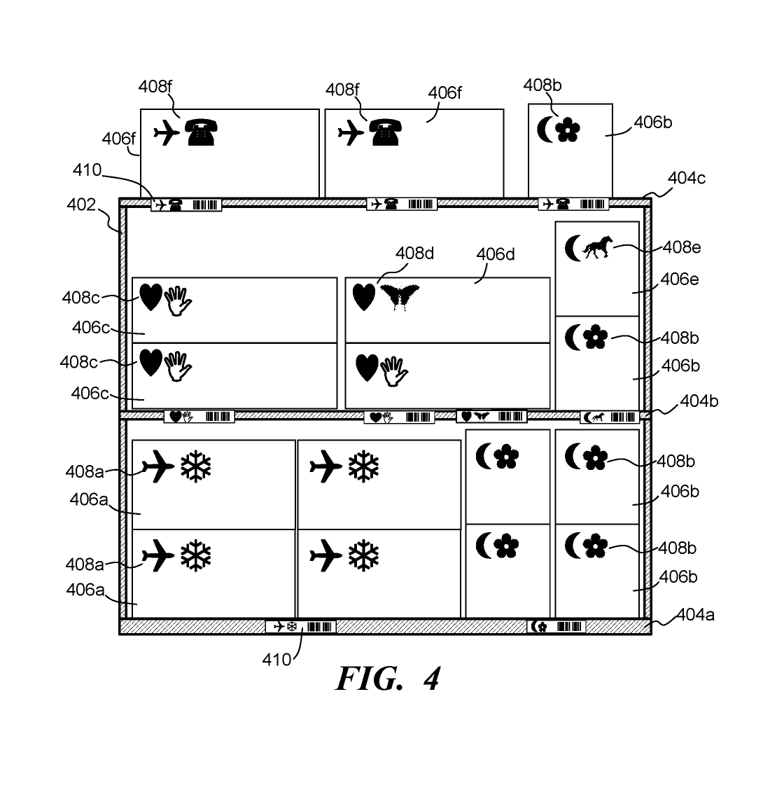

FIG. 4 illustrates a simplified plane view of an exemplary rack 402, case, shelving, or the like with multiple shelves 404a-c, bins, or other such structures to support and/or hold one or more products or shipping packaging of products 406a-f at the shopping facility. The product packaging and/or shipping packaging of each item of the products 406a-f includes a set 408a-f of two or more symbols. Again, the sets of symbols 408 visually distinguish the product from other products at least at the shopping facility. Further, the set of symbols may be printed or otherwise affixed to one or more sides of the packaging and/or shipping packaging.

In some embodiments, the sets of symbols comprise a set of pictorial symbols. Further, the symbols are typically non-alphanumeric (i.e., does not include letters, numbers or other characters that are typically associated with written language), which allows someone to readily identify a product regardless of what language a person reads or understands, or even when a person cannot read. In some implementations, the set of symbols exclusively corresponds to a unique identifier of the first product, and in some instances corresponds with an identifier that is also used to define a unique machine readable code (e.g., bar code) that is associated with the product.

In the example illustrated in FIG. 4, a first shelf 404a includes two different kinds of products, with a first product 406a having a first set of symbols 408a comprising a silhouette of an airplane and a geometric shape that is representative of a snow flake. A second product 406b has a second set of symbols 408b, which is visually and readily distinguished from the first set of symbols, and includes a pictorial silhouette of a crescent (often associated with a crescent moon) and a flower. Similarly, the second shelf 404b includes four different products 408b-e, including the second product 406b having the second set of symbols 408b, third products 406c having a third set 408c of two symbols of a heart and a human hand, a fourth product 406d having a fourth set 408d of two symbols of a heart and a silhouette of a butterfly, and a fifth product 406e having a fifth set 408e of two symbols of the crescent shape and a silhouette of a horse. The third shelf 404c, in the illustrated example, includes the second product 406b with the second set of symbols 408b, and sixth products 406f having a series of symbols 408f comprising a silhouette of an airplane and a telephone.

Accordingly, a shopping facility worker, when looking at the shelf rack 402 can readily identify and distinguish the second products 406b on each of the first, second and third shelves from the other products also positioned on the shelves 404 or on other racks. Again, the symbols are typically pictorial symbols, and the symbols of the different sets of symbols are readily visibly recognizable by a human worker at the premises of the shopping facility, and each set of symbols is visibly distinguishable by the human worker from hundreds and typically tens of thousands of other sets of symbols.

Further, in some embodiments, one or more labels with one or more sets of symbols may be placed at locations where corresponding products are expected to be and/or intended to be placed. For example, still referring to FIG. 4, one or more shelf labels 410 may also be attached to the front edge or side of the shelves. These shelf labels may be printed to include one or more sets of symbols intended to correspond to the product or products placed at the corresponding location or proximate the location where the shelf label is positioned. The shelf label can help customers, workers and others in identifying where products are to be placed, identifying where products are expected to be placed, subsequently finding products, and other such benefits. Other information may also be included on the shelf label such as, but not limited to, one or more machine readable codes, one or more product names, product manufacturer, an alphanumeric identifier (e.g., corresponding to the machine readable code), other relevant information, or a combination of two or more of such information. For example, one or more shelf labels may be printed with one or more sets of the symbols and at least temporarily affixed to the shelf to be visible to a customer and/or worker. As such, the shelf labels can make it easier for the workers and/or customer to pick the product off the shelf and identify where products are to be placed. Similarly, the shelf labels allow a worker and/or customer to recognize that a particular product is gone when no further products are at the designated location.

The shopping facility worker may be given instructions to locate and/or retrieve one or more desired products. The symbols can be communicated to a shopping facility worker that can be used by the worker to locate the one or more products, identify the products, confirm the products are in a desired or accurate location, retrieve the product for movement (e.g., picking the product from a back storage area and moving it to the shopping floor), and other such acts or actions to be performed by the worker relative to the one or more desired products. The communication can be from the central computer system 102 to a user interface unit 108, printed through a print unit 110, displayed at a computer or the like. In some embodiments, the worker can utilize the communicated set of symbols and visually compare the communicated set of symbols to numerous other sets of symbols that are one multiple products and/or shipping packaging in visually locating the desired product.

Again, products are typically labeled with a set of symbols, which includes two or more symbols. In some embodiments, one or more symbols are configured to be uniquely and exclusively associated with a source of a product. Further, a symbol corresponding to a source is visibly distinct from other symbols that are exclusively associated with other sources of other products. The sources of the products can be manufacturers, suppliers, shippers, importers, or other such sources. Accordingly, each source may have one or more symbols that correspond exclusively to that source. Referring back to FIG. 4, for example, a first source may be associated with the silhouette of the airplane, such that the first product 406a (with the set of symbols of the silhouette of the airplane and the snow flake shape) and the sixth product 406f (with the set of symbols of the silhouettes of the airplane and the telephone) are provided from the first source. Similarly, a second source may be associated with the crescent shape symbol of both the second product 406b (with the set of symbols of the crescent shape and the flower) and the fifth product 406e (with the set of symbols of the crescent shape and the silhouette of the horse). Further, in the example of FIG. 4, a third source may be associated with the heart shape symbol of both the third product 406c (with the set of symbols of the heart shape and the human hand) and the fourth product 408d (with the set of symbols of the heart shape and the silhouette of the butterfly).

The one or more other symbols of the sets of symbols 408, in some implementation, are configured to distinguish each product provided by a particular source. In some embodiments, the second symbol (and/or subsequent symbols) corresponds to, for example, a first product from a first source, and the second symbol is unique relative to multiple other symbols corresponding to other products from the first source. Again, the second symbol is visibly distinct from the multiple other symbols corresponding to the other products from at least the first source. Referring to the example illustrated in FIG. 4 for example, a first source (identified by the airplane symbol) may be associated the first product 406a and the sixth product 406f, with the snow flake shape symbol of the first set of symbols 408a distinguishing the first product 406a from the telephone symbol of the sixth set of symbols 408f that identifies the sixth product 406f. As a further example, the flower shape symbol, of the second set of symbols 408b corresponding to the second product 406b supplied by the second source, distinguishes the second product from the fifth product 406e (with the corresponding silhouette of a horse symbol of the fifth set of symbols) that is also supplied from the second source. In yet another example, the third and fourth products 406c-d from the third source are distinguished by their respective second symbols, i.e., the human hand shape versus the silhouette of a butterfly, and thus readily distinguish the third and fourth products from the third source.

Typically, the pictorial representation of the second symbol of the various set of symbols does not pictorially illustrate a representation of an item of the first product. Instead, the second symbol is independent of the product and is not intended to provide information about the type of product with which the set of symbols corresponds. For example, when the product is disposable cups, the second symbol typically is not a silhouette of a cup, but instead is usually unrelated to a cup, such as a pictorial representation of an apple. As such, in many instances, the symbols are not intended to portray or represent a type of product with which it is associated.

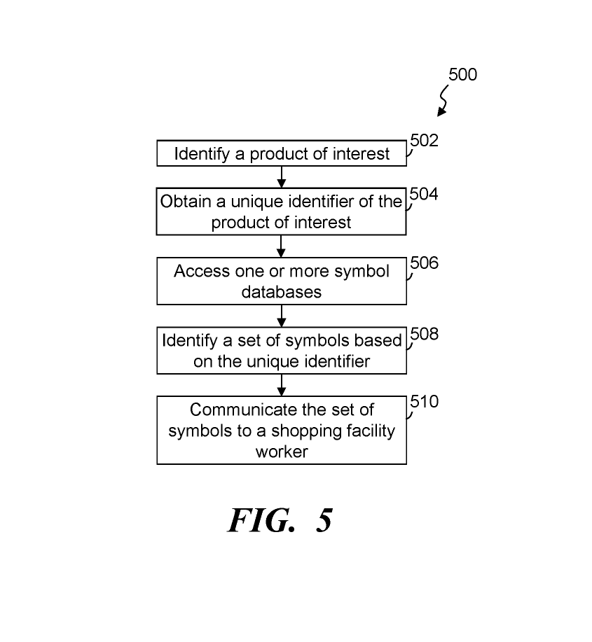

FIG. 5 illustrates a simplified flow diagram of an exemplary process 500 allowing a shopping facility worker or other individual to distinguish and locate a product of interest, in accordance with some embodiments. In some implementation, some or all of the process is implemented by the central computer system, which may be part of or in communication with an inventory system of a shopping facility configured to provide a dynamic shopping interface. In step 502, a product of interest that is physically at a shopping facility is identified that is to be found within the shopping facility by a shopping facility worker. There may be one or more reasons why the product of interest is being identified, such as but not limited to, as picking a product to be moved from a back storage area to the sales floor, confirming the items of the product of interest are placed in a correct location (e.g., on a correct shelf at a correct location on the sales floor), performing an audit of at least the product of interest, retrieving one or more items of the product of interest in response to a request from a customer, confirming the product of interest is in a correct location within the shopping facility (e.g., positioned on a correct shelf), and other such reasons.

In step 504, a unique identifier of the product of interest is obtained. In some implementations, the identifier is obtained from an inventory database. For example, the central computer system may provide the inventory database with information about a product (e.g., name, code, etc.) and receive the corresponding unique identifier from the inventory database. As another example, a bar code may be scanned by a shopping facility worker on the sales floor, which is communicated to the central computer system requesting a shelf be restocked with the product of interest. The central computer system may communicate with the inventory database and use the identifying information from the scanned bar code to confirm the bar code identifier and/or confirm that further items of the product are available for restocking. Similarly, the code may be communicated from a point of sale device. In other instances, an inventory system and/or a worker may identify that an audit should be performed relative to one or more products and provide the unique identifier. In step 506, one or more symbol databases are accessed. In some embodiments, the access to the symbol database is in response to an act or action that is to be performed in association with the desired product (e.g., restocking, auditing, moving and/or in-store overstock management, processing shipments received, other such actions, or combinations of two or more of such actions).

In step 508, a set of pictorial, non-alphanumeric symbols are identified from the symbol database based on the unique identifier of the product of interest. Again, the set of symbols 408 exclusively corresponds to the unique identifier of the product of interest. Further, in some embodiments, each symbol of the set of symbols is readily visibly recognizable by a human worker at the premises of the shopping facility and the set of symbols is visibly distinguishable by the human worker from hundreds or more of other sets of symbols.

In step 510, the set of symbols exclusively corresponding to the unique identifier of the product of interest is communicated to the shopping facility worker. Again, the communication can be a wireless communicate to a user interface unit 108 and displayed through the user interface unit, displayed on a display screen of the central computer system, printed by a print unit 110, displayed through a display screen of a computer system and/or point of sale (POS) system, or other such communication methods. Typically, the set of symbols is communicated in association with the act to be performed by the shopping facility worker corresponding to finding the product of interest within the shopping facility. Using the communicated set of symbols a worker can locate one or more items of the product of interest with the product of interest being visibly identifiable by the shopping facility worker through a visual comparison of the set of symbols with multiple different sets of symbols affixed to multiple different products within the shopping facility.

As described above, in some instances, products are received that do not include the unique set of symbols on the products and/or shipping packaging. In such instances, with at least some products, the set of symbols may be printed through a print unit and at least temporarily affixed to the product and/or shipping packaging. In some embodiments, for example, central computer system 102 (e.g., through the control circuit 202) may be configured to receive a notification that multiple items of a product are received at the shopping facility. In response to receiving the notification, the control circuit can cause the first set of symbols to be printed on multiple labels configured to be affixed to each of the multiple items of the first product. Further, in some embodiments, the control circuit 202 may be further configured to receive a notification that at least one of the first product is to be stored at the shopping facility based on an inventory management of the first product. For example, in stocking one or more shelves on the retail floor it may be identified that not all of a first product will fit (e.g., less than a full case will fit). Accordingly, as part of an inventory management, some embodiments identify and/or receive an identification of products that are going to be placed in a back storage area, an overstock area or otherwise placed within the shopping facility as part of inventory management. Further, as part of moving products based on the inventory management and/or placement of the products, some embodiments print one or more labels of one or more sets of symbols corresponding to the products. For example, in some implementations, the control circuit can be configured to cause, in response to receiving a notification that one or more products are to be stored, one or more sets of symbols to be printed on one or more labels configured to be affixed shipping packaging of the one or more product to be stored, affixed to one or more of the product to be stored, affixed to a shelf or rack upon which the product to be stored is placed, or otherwise placed proximate the product such that a shopping facility worker can visually and easily identify and distinguish the product from other products.

In some instances, sets of symbols may not be printed on or affixed to all products, and instead the sets of symbols may be limited to predefined products, based on conditions at the shopping facility, and/or other such factors. For example, in some instances, one or more sets of symbols may be applied to certain products, one or more sets of symbols may be applied to products that are placed in predefined areas, sets of symbols may be applied based on a quantity of a product is at a shopping facility, and/or other such conditions.

In one example, upon receiving a first product it may be a shopping facility practice to move the received product out to the shopping floor without the set of symbols on the product. When one or more of the product cannot be moved to the shopping floor (e.g., insufficient space on the shopping floor), one or more products may be moved to a back storage and/or overstock storage location, with a set of symbols may be affixed to those products and/or shipping packaging of those products that are moved to the back storage/overstock location. Accordingly, when a worker is instructed to restock that particular product of interest, the worker can be provided with the set of symbols for the product of interest allowing the worker to readily identify the product of interest in the back storage and/or overstock location or locations.

In another example, one or more labels can be printed from a printing unit to include at least one set of symbols. The labels can be applied to products and/or product shipping packaging when products are received at the shopping facility. Some of the products may be moved to the retail floor while some may be stored in a storage area (e.g., limiting the quantity that is displayed on the retail floor, limited space on the retail floor, etc.). This allows a worker to receive the communication with the corresponding set of symbols and readily identify the product of interest in amongst tens to hundreds or more different products.

As yet another example, a worker may be instructed to confirm that products placed at a certain location on a shelf or other support structure are actually the product intended to be at the certain location. Providing the worker with the corresponding set of symbols for the products intended to be at the certain location, the worker is able to rapidly and visually confirm whether one or more products are incorrectly placed at the certain location on the shelf. As a specific example, the packaging of each item may include on at least an upper surface a first set of symbols. The first set of symbols is communicated to the worker. By visually inspecting products from the top, the worker is able to readily see when a second set of symbols on an incorrectly placed product which visually stands out amongst the first set of symbols on multiple correctly placed products surrounding the incorrectly placed product.

In some embodiments, the symbol within the set of symbols corresponding to each product source or supplier may be selected by the product source, selected by a shopping facility, assigned by a central symbol distributor to which all suppliers submit requests for symbols, assigned by a third party, or by some other entity. For example, a product source for one or more products may submit one or more symbols to a shopping facility requesting that the one or more symbols be exclusively associated with that product source. The shopping facility may evaluate the request and authorize the request when there is not another symbol corresponding to another product source that is the same or similar to the requested one or more symbols. The selection of a second one or more symbols corresponding to a product and distinguishing the product supplied by a source, in some instances, may similarly be selected by the product source, the shopping facility, assigned by a central symbol distributor, assigned by a third party, or the like. In some implementations, because the first symbol of a set of symbols may distinguish between potential product sources, the second symbol may be left to the product source to select. The selection of the second symbol may be restricted by certain criteria, such as non-alphanumeric, pictorial, simple (e.g., silhouette, relatively few lines, etc.), single color, other such criteria, or combinations of two or more of such criteria. Further, in many instances the second symbol in a set of symbols does not have to be completely unique, and instead may be to be unique relative to the products provided a product supplier.

As described herein, the sets of symbols are intended to uniquely identify the product and distinguish the product from other products at least at the shopping facility. In some implementations, each set of symbols corresponds to a unique identifier of the product with which the set of symbols is associated. In some instances, each set of symbols corresponds to a machine readable code that exclusively corresponds to a unique identifier of the corresponding product. Further, the machine readable code may be configured to include a source identifier code or source identifier code portion of a code of a product source for a corresponding product, and a product identifier code or product identifier code portion of a code of a corresponding product. Accordingly, the sets of symbols may, in some implementations, correspond to a machine readable code.

The symbols are printed and/or affixed to the products, product packaging and/or shipping packaging in a location or locations that are typically visible depending on an expected placement within the shopping facility. For example, the set of symbols may be applied to at one or more locations on each side as well as on a top and/or bottom of a product, product packaging and/or shipping packaging. This allows the set of symbols to be visible from substantially any angle when the product is in view.

Again, the symbols of the sets of symbols are typically pictorial symbols. Further, the symbols are typically not letters, words, numbers or other such readable text, and further are typically language independent. As such, shopping facility worker (e.g., associates, colleagues or other such workers) can visually distinguish a particular product from other products without even knowing what the product she/he is looking for and regardless of whether a shopping facility worker can read or what language the shopping facility worker can read.

In some embodiments, apparatuses and methods are provided herein useful to assist in visually identifying and/or locating products. In some embodiments, a shopping facility management system comprises: an inventory database; a symbol database; a control circuit coupled to the inventory database and the symbol database; and a memory coupled to the control circuit and storing computer instructions that when executed by the control circuit cause the control circuit to: identify a first product physically at a shopping facility that is to be found within the shopping facility by a shopping facility worker; obtain a unique identifier of the first product; access the symbol database; identify, from the symbol database and based on the unique identifier, a first set of pictorial, non-alphanumeric symbols exclusively corresponding to the unique identifier of the first product, wherein each symbol of the first set of symbols is readily visibly recognizable by a human worker at a premises of the shopping facility and the first set of symbols is visibly distinguishable by the human worker from hundreds of other sets of symbols; and communicate to the shopping facility worker the first set of symbols exclusively corresponding to the unique identifier of the first product in association with an act to be performed by the shopping facility worker corresponding to finding the first product within the shopping facility such that the first product is visibly identifiable by the shopping facility worker through a visual comparison of the first set of symbols communicated to the shopping facility worker to multiple different sets of symbols affixed to multiple different products within the shopping facility.

In some embodiments, a method providing product management comprises: by a control circuit of an inventory system of a shopping facility: identifying a first product physically at a shopping facility that is to be found within the shopping facility by a shopping facility worker; obtaining a unique identifier of the first product; accessing a symbol database; identifying, from the symbol database and based on the unique identifier, a first set of pictorial, non-alphanumeric symbols exclusively corresponding to the unique identifier of the first product, wherein each symbol of the first set of symbols is readily visibly recognizable by a human worker at a premises of a shopping facility and the first set of symbols is visibly distinguishable by the human worker from hundreds of other sets of symbols; and communicating to the shopping facility worker the first set of symbols exclusively corresponding to the unique identifier of the first product in association with an act to be performed by the shopping facility worker corresponding to finding the first product within the shopping facility such that the first product is visibly identifiable by the shopping facility worker through a visual comparison of the first set of symbols communicated to the shopping facility worker to multiple different sets of symbols affixed to multiple different products within the shopping facility.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A shopping facility management system, comprising:
an inventory database;
a symbol database;
a control circuit coupled to the inventory database and the symbol database; and
a memory coupled to the control circuit and storing computer instructions that when executed by the control circuit cause the control circuit to:
identify a first product physically at a shopping facility that is to be found within the shopping facility by a shopping facility worker;
obtain a unique identifier of the first product;
access the symbol database;
identify, from the symbol database and based on the unique identifier, a first set of pictorial, non-alphanumeric symbols exclusively corresponding to the unique identifier of the first product, wherein each symbol of the first set of symbols is readily visibly recognizable by a human worker at a premises of the shopping facility and the first set of symbols is visibly distinguishable by the human worker from hundreds of other sets of symbols; and
communicate to the shopping facility worker the first set of symbols exclusively corresponding to the unique identifier of the first product in association with an act to be performed by the shopping facility worker corresponding to finding the first product within the shopping facility such that the first product is visibly identifiable by the shopping facility worker through a visual comparison of the first set of symbols communicated to the shopping facility worker to multiple different sets of symbols affixed to multiple different products within the shopping facility.

2. The system of claim 1, wherein the first set of symbols comprises a first symbol and a second symbol, wherein the first symbol is unique and exclusively associated with a first source of the first product and is visibly distinct from other symbols exclusively associated with other sources of other products.

3. The system of claim 2, wherein the second symbol corresponds to the first product from the first source and is unique relative to multiple other symbols corresponding to other products from the first source and is visibly distinct from the multiple other symbols corresponding to the other products from the first source.

4. The system of claim 3, wherein the pictorial representation of the second symbol does not pictorially illustrate a representation of an item of the first product.

5. The system of claim 1, wherein the first set of symbols corresponds to machine readable code that exclusively corresponds to the unique identifier of the first product, wherein the machine readable code includes a source identifier code of a source of the first product and a product identifier code of the first product.

6. The system of claim 1, wherein the control circuit is further configured to:
receive a notification that multiple items of the first product are received at the shopping facility; and
cause, in response to receiving the notification, the first set of symbols to be printed on multiple labels configured to be affixed to each of the multiple items of the first product.

7. The system of claim 1, wherein the control circuit is further configured to:
receive a notification that at least one of the first product is to be stored based on an inventory management of the first product; and
cause, in response to receiving the notification that at least one of the first product is to be stored, the first set of symbols to be printed on one or more labels configured to be affixed to at least one of shipping packaging of the at least one of the first product to be stored and one or more of the least one of the first product to be stored.

8. The system of claim 1, wherein the control circuit in communicating the first set of symbols to the shopping facility worker is configured to wirelessly communicate the first set of symbols to a user interface unit utilized by the shopping facility worker to cause the user interface unit to display the first set of symbols to the shopping facility worker.

9. A method providing product management, comprising:
by a control circuit of an inventory system of a shopping facility:
identifying a first product physically at a shopping facility that is to be found within the shopping facility by a shopping facility worker;
obtaining a unique identifier of the first product;
accessing a symbol database;
identifying, from the symbol database and based on the unique identifier, a first set of pictorial, non-alphanumeric symbols exclusively corresponding to the unique identifier of the first product, wherein each symbol of the first set of symbols is readily visibly recognizable by a human worker at a premises of a shopping facility and the first set of symbols is visibly distinguishable by the human worker from hundreds of other sets of symbols; and
communicating to the shopping facility worker the first set of symbols exclusively corresponding to the unique identifier of the first product in association with an act to be performed by the shopping facility worker corresponding to finding the first product within the shopping facility such that the first product is visibly identifiable by the shopping facility worker through a visual comparison of the first set of symbols communicated to the shopping facility worker to multiple different sets of symbols affixed to multiple different products within the shopping facility.

10. The method of claim 9, wherein the first set of symbols comprises a first symbol and a second symbol, wherein the first symbol is unique and exclusively associated with a first source of the first product and is visibly distinct from other symbols exclusively associated with other sources of other products.

11. The method of claim 10, wherein the second symbol corresponds to the first product from the first source and is unique relative to multiple other symbols corresponding to other products from the first source and is visibly distinct from the multiple other symbols corresponding to the other products from the first source.

12. The method of claim 11, wherein the pictorial representation of the second symbol does not pictorially illustrate a representation of an item of the first product.

13. The method of claim 9, wherein the first set of symbols corresponds to machine readable code that exclusively corresponds to the unique identifier of the first product, wherein the machine readable code includes a source identifier code of a source of the first product and a product identifier code of the first product.

14. The method of claim 9, further comprising:
receiving a notification that multiple items of the first product are received at the shopping facility; and
causing, in response to receiving the notification, the first set of symbols to be printed on multiple labels configured to be affixed to each of the multiple items of the first product.

15. The method of claim 9, wherein the communicating the first set of symbols to the shopping facility worker comprises wirelessly communicate the first set of symbols to a user interface unit utilized by the shopping facility worker to cause the user interface unit to display the first set of symbols to the shopping facility worker.

16. The method of claim 9, further comprising:
receiving a notification that at least one of the first product is to be stored based on an inventory management of the first product; and
causing, in response to receiving the notification that at least one of the first product is to be stored, the first set of symbols to be printed on one or more labels configured to be affixed to at least one of shipping packaging of the at least one of the first product to be stored and one or more of the least one of the first product to be stored.
